(19) United States
(12) Patent Application Publication
(10) Pub. No.: US 2024/0380232 A1
(43) Pub. Date: Nov. 14, 2024

(54) METHODS AND SYSTEMS FOR OPTIMIZED FAST CHARGING

(71) Applicant: Ford Global Technologies, LLC, Dearborn, MI (US)

(72) Inventor: Vasileios Tsormpatzoudis, London (GB)

(21) Appl. No.: 18/196,562

(22) Filed: May 12, 2023

(51) Int. Cl. H02J 7/00; B60L 53/62; H01M 10/44

(52) U.S. Cl. CPC H02J 7/007188; B60L 53/62; H01M 10/441; H01M 10/443; H01M 10/445; H02J 7/0029; B60L 2240/545; B60L 2240/547; B60L 2240/549

(57) ABSTRACT

Systems and methods for optimized fast charging are provided. The methods comprise providing a charging current to a battery pack of a vehicle from an external power source, detecting a change in volume of one or more battery cells of a battery pack, and adjusting the charging current as a function of the volume change of the one or more battery cells of the battery pack.

### FIELD

The present invention relates to a system for detecting swelling of a battery cell, and more particularly but not exclusively, to a system and a method of detecting swelling of a battery cell and optimizing the charging of the battery cell, in which sensors are provided in spaces between one or more battery cells, and charging current of an external power source is controlled based on sensor output, preventing damage generable by a swelling phenomenon of the battery cell and a structural deformation of a battery cell and a battery pack.

### BACKGROUND

Direct current fast charging (DCFC) is a method of quickly charging a battery system using a high current. Fast charging seeks to obtain 80% of a battery's state of charge (SOC) within 15 minutes or less, which means the battery system can be charged to a SOC of 80% at a C-rate of 4C or higher. However, DCFC can lead to rapid capacity fade, thus users cannot utilize this feature very often. A typical DCFC profile, often has current peaks (boosts) at the early stage of the cycle and then it is reduced to protect the battery from (a) overcharging and (b) high temperatures.

When being charged, battery cells expand. Research has shown that laser triangulation can be used to measure a cell's expansion in controlled conditions. However, when the cells are packaged into modules, it is difficult to measure the expansion of the cells.

Accordingly, the related art presents various technologies for detecting a swelling phenomenon of a battery, and discloses cutting power during overcharging of a battery. For example, when a swelling phenomenon is generated in a battery, a connection between an electrode assembly and an electrode lead may be broken, so that a power connection unit between cells is disconnected, thereby preventing overcharging.

### SUMMARY

By way of summary this disclosure relates to systems and methods to optimize fast charging based on the swelling detection of a battery. Taking into consideration an expansion of one or more battery cells, a controller can optimize the DCFC experience for the user while reducing both the overall charging time and the capacity fade experienced by the battery. In particular, in some examples, a charging profile may change to a multi-stage constant current-constant voltage (MSCC-CV) profile, where a current decrease will occur when the controller detects cell expansion, e.g., of a predetermined amount.

According to a first approach, there is provided a method for optimizing charging of a vehicle, the method comprising: providing a charging current to a battery pack of a vehicle from an external power source; detecting a change in volume of one or more battery cells of a battery pack; and adjusting (e.g., reducing) the charging current as a function of the volume change (e.g., increase) of the one or more battery cells of the battery pack.

In some examples, the charging is provided at a C-rate greater than 1C. In some examples, the function that describes the charging current is a MSCC-CV function.

In some examples, the method further comprises: receiving, from at least one sensor, a voltage value; comparing the voltage value with a threshold voltage value; determining whether the voltage value has exceeded the threshold voltage value; and wherein the function adjusting the charging current is based on a magnitude of the detected voltage value over the threshold voltage value.

In some examples, the method further comprises determining whether the voltage value has fallen below the threshold voltage value; wherein the function adjusting the charging current is no longer based on the magnitude first voltage value over the threshold voltage value.

In some examples, the method further comprises receiving, from at least one sensor, a current value; comparing the current value with a threshold current value; determining whether the current value has exceeded the threshold current value; wherein the function adjusting the charging current is further based on a magnitude of the detected current value over the threshold current value.

In some examples, the method further comprises determining whether the current value has fallen below the threshold current value; wherein the function adjusting the charging current is no longer based on the magnitude first current value over the threshold current value.

In some examples, at least a first pressure measuring sensor is provided in a space directly between adjacent battery cells among the one or more battery cells and is configured to measure pressure applied directly by the adjacent battery cells and output a voltage or current value corresponding to the pressure.

In some examples, a second pressure measuring sensor is provided in a space formed by an outermost battery cell among the one or more battery cells and an inner wall of the battery pack and is configured to measure pressure applied directly by the outermost battery cell and output a voltage or current calue corresponding to the pressure.

In some examples, at least a first temperature measuring sensor is provided in a space directly between adjacent battery cells among the one or more battery cells and is configured to measure temperature from the adjacent battery cells and output a voltage or current value corresponding to the temperature.

In some examples, at least a first camera sensor is provided in a space with a view of one or more battery cells and is configured to measure at least one dimension from the one or more battery cells and output a voltage or current value corresponding to the dimension measured.

In another approach, there is provided a system for optimizing charging based on swelling detection, the system comprising: a detecting unit communicatively coupled to a battery pack, wherein the detecting unit is configured to detect a change in volume of one or more battery cells of the battery pack; a control unit in electrical connection with the battery pack and an external power source, wherein the control unit is configured to: provide a charging current to the battery pack from the external power source; and adjust the charging current as a function of the volume change of the one or more battery cells of the battery pack. The one or more battery cells may form a space having a predetermined interval and may be embedded in the battery pack.

In another approach, there is provided a vehicle comprising a system for optimizing charging based on swelling detection, the system comprising: a detecting unit communicatively coupled to a battery pack, wherein the detecting unit is configured to detect a change in volume of one or more battery cells of the battery pack; a control unit in electrical connection with the battery pack and an external power source, wherein the control unit is configured to: provide a charging current to the battery pack from the external power source; and adjust the charging current as a function of the volume change of the one or more battery cells of the battery pack.

In another approach, there is provided a non-transitory computer-readable medium, having instructions recorded thereon for optimizing charging based on swelling detection, the instructions, when executed by control circuitry, cause the control circuitry to: provide a charging current to a battery pack of a vehicle from an external power source; detect a change in volume of one or more battery cells of a battery pack; and adjust the charging current as a function of the volume change of the one or more battery cells of the battery pack.

Accordingly, the present invention has an advantage in that it is possible to prevent life shortening and a structural deformation of a battery by an abnormal swelling phenomenon of a battery cell.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 is an illustrative flowchart of a process for optimized charging of a vehicle, in accordance with some examples of the present disclosure;

FIG. 2 is an illustrative flowchart of a process for altering an optimized charging of a vehicle considering the voltage value received form a sensor, in accordance with some examples of the present disclosure;

FIG. 3 is an illustrative flowchart of a process for altering an optimized charging of a vehicle considering the current value received form a sensor, in accordance with some examples of the present disclosure;

FIGS. 4 and 5 are illustrative flowcharts of a process for altering a function reducing a charging current based on detected values, in accordance with some examples of the present disclosure;

FIG. 6 illustrates a vehicle, in accordance with some examples of the present disclosure; and

FIG. 7 illustrates a block diagram of a computing module, in accordance with some examples of the disclosure.

### DETAILED DESCRIPTION

Direct current (DC) fast charging is a technology used to rapidly recharge electric vehicles (EVs) by providing high levels of electric power directly to the vehicle's battery pack. In contrast to alternating current (AC) charging, which is the standard charging method used in most homes and public charging stations, DC fast charging can charge an EV up to 80% capacity in as little as 30 minutes. In some examples, DC fast charging can charge an EV up to 80% capacity in less than 30 minutes, for example 10 minutes.

DC fast chargers use a high-powered charging system that can supply a voltage between 200 and 800 volts, depending on the vehicle's battery and charging specifications. The charging system can deliver a high current flow of up to 400 amps, which is much faster than what is possible with AC charging. The high current flow also generates a lot of heat, so DC fast chargers often have cooling systems to prevent overheating.

DC fast charging stations are typically located at public charging stations, rest areas, and along highways. They are usually more expensive to use than AC charging stations due to their higher power output and faster charging times. However, they provide a convenient and practical solution for EV drivers who need to recharge their vehicles quickly, especially on longer trips where range anxiety may be a concern.

While DC fast charging is a convenient and practical solution for recharging electric vehicles quickly, there are a few issues associated with this charging method:

Battery degradation: Rapid charging generates heat, which can degrade the battery and shorten its lifespan over time. The high charging currents used in DC fast charging can also cause the battery to degrade faster than with slower charging methods.

Cost: DC fast charging stations are more expensive to install and maintain than AC charging stations, and the higher power output and faster charging times make them more expensive to use.

Grid capacity: DC fast charging can put a strain on the electrical grid, especially during peak usage periods. This can lead to issues with grid stability and reliability, and may require additional infrastructure investment to support increased demand for fast charging.

Range anxiety: While DC fast charging can provide a rapid charge to an electric vehicle, it may not be available in all locations, which can cause range anxiety for drivers. This can limit the practicality and convenience of electric vehicles for long-distance travel.

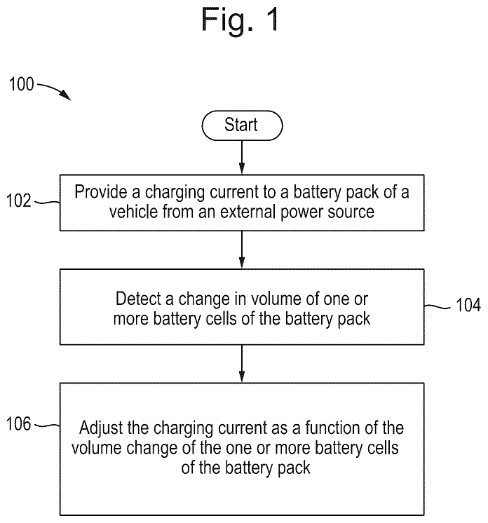

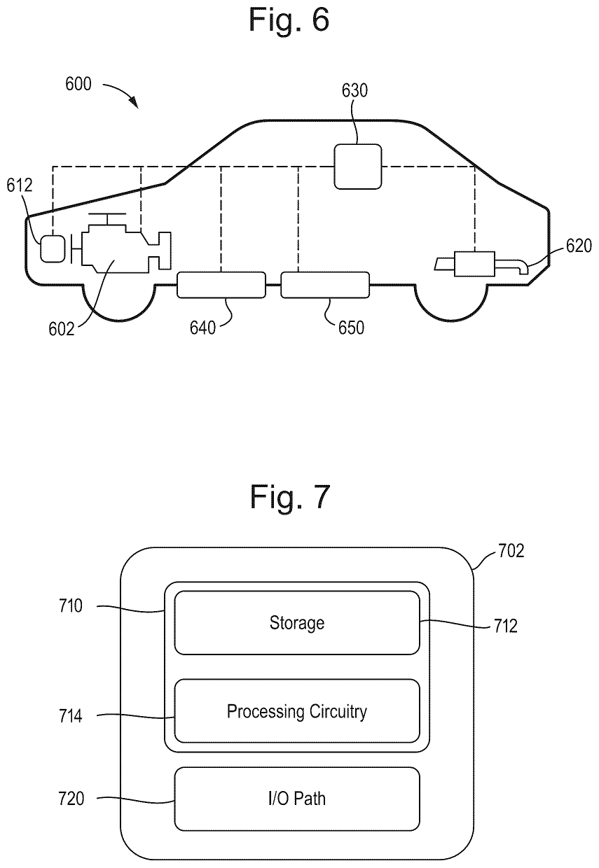

FIG. 1 is an illustrative flowchart of a process for optimized charging of a vehicle, in accordance with some examples of the present disclosure. Process 100 disclosed in FIG. 1 may be carried out by a control system such as the control unit 630 of FIG. 6. Process 100 starts at step 102.

At step 102, a charging current is provided to a battery pack of a vehicle from an external power source. DC fast charging can contribute to capacity fade and battery expansion in electric vehicle batteries. Capacity fade is a gradual loss of the battery's ability to hold a charge, which can occur over time due to various factors, including the high charging currents used in DC fast charging. Rapid charging generates heat, which can degrade the battery and lead to capacity fade over time. Battery expansion occurs when the battery cells expand due to the buildup of gas within the cells during the charging process. This expansion can cause damage to the battery and reduce its overall lifespan. DC fast charging can increase the likelihood of battery expansion, especially if the battery is already at a high state of charge.

To minimize these issues, manufacturers may design their batteries to be more resistant to capacity fade and battery expansion. In other circumstances, control strategies are desired that are designed to manage the charging process to reduce the risk of battery degradation.

At step 104, a change in volume of one or more battery cells of the battery pack is detected. The volume expansion of battery cells can be difficult to measure while the battery is installed in an electric vehicle, as it typically requires disassembling the battery pack to access the individual cells. However, there are a few methods that can be used to estimate the volume expansion of the battery cells while in the vehicle:

Electrochemical impedance spectroscopy (EIS): EIS is a technique used to measure the impedance of the battery cells, which can provide information about the state of the cells and their volume expansion. While EIS cannot directly measure the volume expansion, it can provide an indirect estimate based on changes in the cell impedance.

Ultrasonic testing: Ultrasonic testing uses sound waves to measure the thickness and expansion of the battery cells. This technique can be used to estimate the volume expansion of the cells, although it requires specialized equipment and may be difficult to perform on a fully-assembled battery pack.

Modeling: Battery models can be used to simulate the behavior of the cells and estimate their volume expansion based on factors such as charging rate, temperature, and state of charge. While these models may not be as accurate as direct measurements, they can provide valuable insight into the behavior of the battery cells and help optimize charging and discharging strategies to minimize volume expansion and other forms of battery degradation.

At step 106, the charging current is reduced as a function of the volume increase of the one or more battery cells of the battery pack. By monitoring and managing the volume expansion of the battery cells, and adjusting the charging current accordingly, the vehicle system can benefit in several ways:

Improved battery health: Knowing the volume expansion of the battery cells can help the vehicle management system to predict and prevent battery degradation. If the volume expansion of the cells is too high, the system can adjust the charging and discharging strategy to reduce the stress on the cells and minimize damage.

Increased efficiency: Battery cells that are expanded beyond their design limits can lead to increased resistance and reduced efficiency. By monitoring the volume expansion of the cells, the vehicle management system can optimize the charging and discharging strategy to maintain the efficiency of the battery and maximize the range of the vehicle.

Extended battery life: By managing the volume expansion of the battery cells, the vehicle management system can help to extend the lifespan of the battery. By minimizing the stress on the cells and preventing excessive expansion, the system can help to reduce the rate of battery degradation and increase the overall lifespan of the battery.

Overall, monitoring and managing the volume expansion of battery cells is an important part of maintaining the health and performance of a hybrid or electric vehicle battery. By optimizing the charging and discharging strategy based on the volume expansion of the cells, the vehicle management system can help to maximize the efficiency, range, and lifespan of the battery.

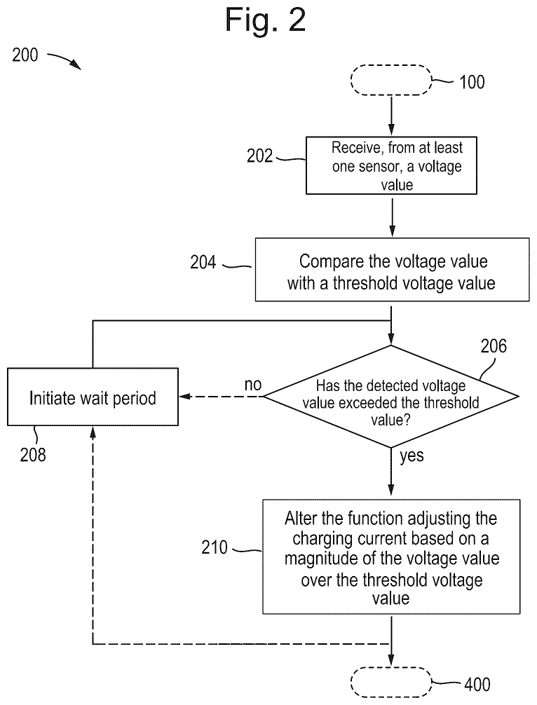

FIG. 2 is an illustrative flowchart of a process for altering an optimized charging of a vehicle considering the voltage value received form a sensor, in accordance with some examples of the present disclosure. Processes 200 disclosed in FIG. 2 may be carried out by a control system such as the control unit 630 of FIG. 6. Process 200 starts at step 202.

At step 202, a voltage value, e.g., a detected voltage value, is received from at least one sensor. At step 204, the detected voltage value is compared with a threshold voltage value. At step 206, it is determined if the detected voltage value has exceeded a threshold voltage value. If the answer to step 206 is no, process 200 continues on to step 208. If the answer to step 206 is yes process 200 continues on to step 210.

In some examples, when the voltage value or the current value exceeds the threshold voltage value (e.g., a predetermined threshold voltage value), the control unit 630 may provide a control signal to a separate peripheral device, and the separate peripheral device may be one of an air-cooling type fan and a water-cooling type cooling valve.

At step 208, a waiting period is initiated before process 200 reverts back to step 206. At step 210, the function reducing the charging current is altered based on the magnitude of the detected voltage value over the threshold voltage value.

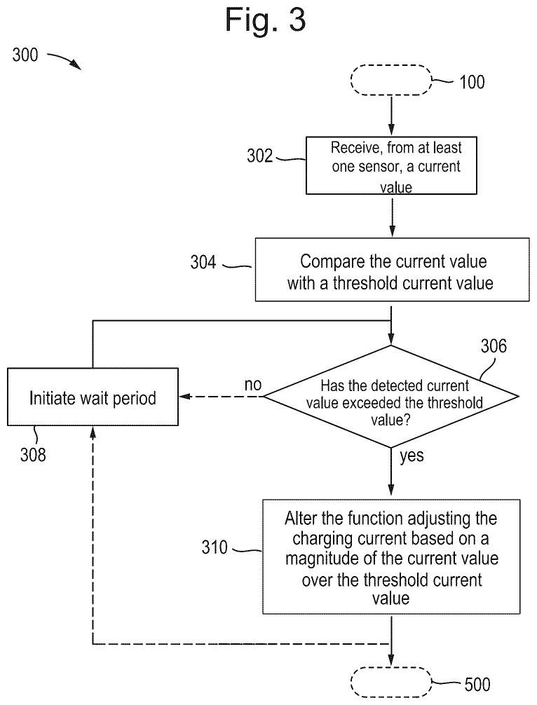

Similar to FIG. 2, but considering current, FIG. 3 is an illustrative flowchart of a process for altering an optimized charging of a vehicle, in accordance with some examples of the present disclosure. Processes 300 disclosed in FIG. 3 may be carried out by a control system such as the control unit 630 of FIG. 6. Process 300 starts at step 302.

At step 302, a current value, e.g., a detected current value, is received from at least one sensor. At step 304, the detected current value is compared with a threshold current value. At step 306, it is determined if the detected current value has exceeded the threshold current value. If the answer to step 306 is no, process 300 continues on to step 308. If the answer to step 306 is yes process 300 continues on to step 310.

In some examples, when the current value or the current value exceeds the threshold current value (e.g., a predetermined threshold current value), the control unit 630 may provide a control signal to a separate peripheral device, and the separate peripheral device may be one of an air-cooling type fan and a water-cooling type cooling valve.

At step 308, a waiting period is initiated before process 300 reverts back to step 306. At step 310, the function reducing the charging current is altered based on the magnitude of the detected current value over the threshold current value.

A battery energy control module (BECM) of a vehicle is responsible for managing the charging and discharging of the battery, as well as monitoring its state of charge and health. While the BECM may not be able to directly optimize vehicle charging based on volume expansion information, it can use this information to adjust the charging and discharging strategy to minimize stress on the battery cells and prevent damage.

For example, if the BECM detects that the volume expansion of the battery cells is higher than normal, e.g., a predetermined volume and/or volume expansion rate, it can reduce the charging rate and/or adjust the charging algorithm to minimize stress on the cells and prevent further expansion. Similarly, if the BECM detects that the battery is at risk of overcharging, it can reduce the charging rate or stop the charging process altogether to prevent damage to the battery cells.

Additionally, the BECM can use other data, such as temperature and state of charge, to optimize the charging and discharging strategy to maintain the health and performance of the battery. By adjusting the charging and discharging strategy based on a combination of factors, including volume expansion, the BECM can help to extend the lifespan of the battery and maximize its performance and efficiency.

CC-CV charging is a charging technique used to charge lithium-ion batteries, which are commonly used in electric vehicles, smartphones, laptops, and other electronic devices. This charging technique involves charging the battery in two stages:

Constant current (CC) stage: In the first stage, the battery is charged with a constant current until it reaches a predetermined voltage, typically around 4.2V for a lithium-ion battery. During this stage, the battery absorbs the maximum amount of charge at a constant rate.

Constant voltage (CV) stage: In the second stage, the charging current is gradually reduced until it reaches a predetermined current while the voltage is held constant at the predetermined level, typically 4.2V. This stage allows the battery to absorb the remaining charge while limiting the voltage to prevent overcharging.

Multi-stage CC-CV (MSCC-CV) charging is a charging technique involving multiple constant current stages. The current magnitude is adjusted between each stage until a predetermined voltage threshold is reached. The CV stage of this technique is similar to the CC-CV charging technique.

By using the MSCC-CV charging technique, the battery can be charged efficiently and safely, while also preventing overcharging and reducing the risk of battery damage. This technique helps to ensure that the battery is charged to its maximum capacity without causing damage or reducing its lifespan. Additionally, MSCC-CV charging can be used with fast-charging systems to quickly charge the battery while still maintaining its health and performance.

Reducing the charging current during the CC stage of charging can help to limit the swelling of a battery cell that is undergoing expansion. When a battery cell is charging, it undergoes a process known as intercalation, in which lithium ions move between the anode and cathode materials. During this process, the volume of the electrode materials can expand, which can cause the battery cell to swell.

By reducing the charging current during the CC stage of charging, the rate of intercalation is reduced, which in turn reduces the volume expansion of the electrode materials. This can help to limit the swelling of the battery cell and prevent damage to the cell structure or surrounding components. However, reducing the charging current too much can also result in longer charging times, which can lead to other issues such as heat buildup and reduced battery life.

Accordingly, in some examples, a reduction of charging current alone may not be enough to prevent battery swelling, as there are other factors that can contribute to volume expansion, such as high temperatures or overcharging. Therefore, in some examples, a combination of charging strategies, such as MSCC-CV charging and temperature monitoring, to manage the swelling of battery cells and maintain the health and performance of the battery is the preferred control strategy.

External factors, such as temperature, can significantly affect the swelling of a battery cell during charging. When a battery cell is charged, it generates heat due to internal resistance, and the temperature of the cell can increase rapidly if the charging current is high or if the ambient temperature is high. High temperatures can increase the rate of intercalation, leading to a greater volume expansion of the electrode materials and more significant swelling of the battery cell.

On the other hand, low temperatures can decrease the rate of intercalation and reduce the volume expansion of the electrode materials, which can lead to less swelling of the battery cell. However, extremely low temperatures can also reduce the efficiency of the charging process and cause the battery to take longer to charge. Furthermore, overcharging the battery can also contribute to the swelling of the battery cell, as it can cause the electrode materials to degrade and produce gas, which can further increase the volume of the cell.

To mitigate the effects of temperature on battery swelling, charging systems often include temperature monitoring and management systems, such as cooling systems, to maintain a safe temperature range during charging. Additionally, charging algorithms can be designed to adjust the charging current or voltage based on the temperature of the battery to reduce the risk of overcharging or overheating. Overall, managing the effects of temperature and other external factors is critical for maintaining the health and performance of lithium-ion batteries.

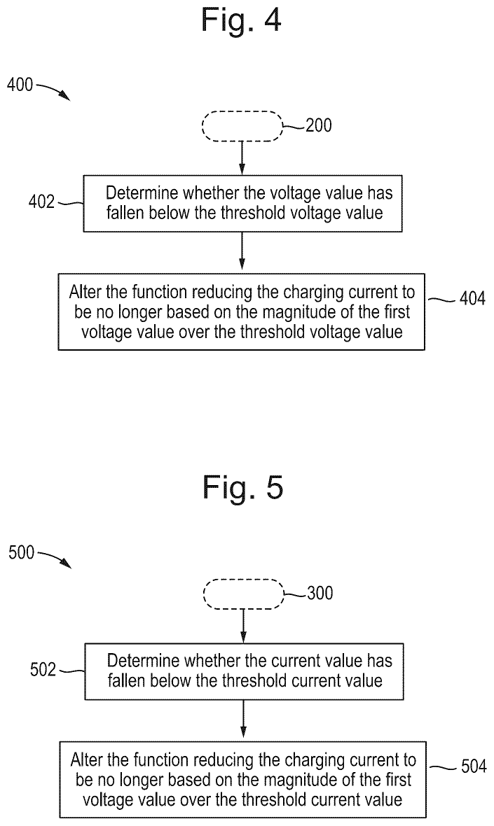

FIG. 4 is an illustrative flowchart of a process for altering a function for reducing a charging current based on detected values, in accordance with some examples of the present disclosure. Process 400 may follow from process 200. Process 400 may be carried out by control unit 630 of FIG. 6. Process 400 starts at step 402.

At step 402, it is determined that the detected voltage value has fallen below the threshold voltage value. At step 404, the function reducing the charging current is altered to be no longer based on the magnitude of the first voltage value over the threshold voltage value.

FIG. 5 is an illustrative flowchart of a process for altering a function for reducing a charging current based on detected values, in accordance with some examples of the present disclosure. Process 500 may follow from process 200. Process 500 may be carried out by control unit 630 of FIG. 6. Process 500 starts at step 502.

At step 502, it is determined that the detected current value has fallen below the threshold current value. At step 504, the function reducing the charging current is altered to be no longer based on the magnitude of the first current value over the threshold current value.

FIG. 6 illustrates a vehicle comprising an engine and an exemplary control system, in accordance with at least one of the examples described herein. FIG. 6 illustrates a vehicle 600 comprising an exhaust system 620, a control module 630, a low voltage battery and bus 640, and a high voltage battery and bus 650, in accordance with at least one of the examples described herein. According to some examples, there is provided a vehicle 600 comprising the control system, as described above. In some examples, the vehicle further comprises a drive train comprising an e-machine 612, an engine 602, clutch and transmission (not shown). The present disclosure is more applicable to a BEV, however, it is also applicable to other electric type vehicle.

The methods described above may be implemented on vehicle 600. Each of the systems in the vehicle is communicatively coupled via control circuitry 630 (illustrated by the dashed line connectors). However, the present disclosure is not limited to the set-up shown in FIG. 6. For example, the control circuitry 630 may be any appropriate type of control circuitry, such as a stand-alone control circuitry, or any other appropriate control circuitry of the hybrid vehicle. For example, control circuitry 630 may, at least in part, be integrated with another control circuitry of the vehicle. Furthermore, the control circuitry 630 may be configured to operationally communicate with any one or more of the vehicle components referred to herein, and/or any other appropriate components of the vehicle. For example, control circuitry 630 may be a stand-alone control circuitry configured to operationally communicate with at an external power source (not shown) and at least one battery pack 640, 650. Furthermore, it is understood that control circuitry 630 may be configured to carry out one or more of the above-disclosed optimized charging methods.

While the example shown in FIG. 6 exemplifies the use of the control system 630 for an EV, it is understood that the control system 630 may be implemented on any appropriate type of electric vehicle, having one or more high-voltage circuit components.

The control circuitry 630 is communicatively coupled to the low voltage battery and bus 640 and the high voltage battery and bus 650 using, for example, CAN and/or LIN protocols. Both protocols allow for the communication of data between devices, and the information can be used to determine the operating properties of the devices. For example, a device could report its current status, such as its temperature, current draw, and voltage, to a central control circuitry 630 over a CAN or LIN network. The central control circuitry 630 could then use this information to optimize the charging current and take account of degradation of the battery pack 650.

In the example shown in FIG. 6, the control circuitry 630 is electrically connected to a low voltage (e.g., 12V) battery and bus 640, which is configured to supply electrical power to one or more low voltage accessories of the EV. The control circuitry 630 is, for example, an engine control module (ECM), in operational communication with each of the e-machine 611, one or more DC-DC converters (if required, not shown), the low voltage battery and bus 640, the high voltage battery and bus 650 (e.g., an EV power system used to power the e-machine 611), and a plurality of other vehicle loads (not shown). The loads may be a compressor used to pump fluids such as water through the high voltage battery and bus 650, the one or more DC-DC converters, and the e-machine 612.

As stated above, each of the systems shown in FIG. 6 are communicatively and/or electrically coupled via control circuitry 630 (illustrated by the dashed line connectors). Shown in FIG. 6 is an e-machine 612, which is a device that may apply positive torque directly to the wheels of the EV, or, in some examples, apply negative torque to generate electrical energy. The e-machine 612 may be referred to as a motor generator. In some examples, the e-machine transmits torque to the wheels via a crankshaft or transmission when it's operating as a motor, and the crankshaft transmits torque back to the e-machine 612 when it operates as a generator, converting kinetic energy from the moving vehicle back into electricity. In particular, the methods disclosed herein that refer to charging from an external power source, may equally apply to the charging provided by the e-machine 612 when applying negative torque and acting as a generator.

By way of further example, the control circuitry 630 can interrogate the BISG 612, components of the aftertreatment system 620, such as an electric exhust gas heater, and other loads, such as compressor pumps for fluids and the like, to determine a total electrical demand already in the vehicle 600. This information, in addition to the peripheral devices connected to the low voltage battery and bus 640 and the high voltage battery and bus 650 by the user, can be used to determine, for example, split charge priorities, and power distribution in the power net of the vehicle 600. By interrogating devices in this way, it is possible to obtain a comprehensive view of the operating properties of a vehicle and its systems, which can help to optimize charging by taking into account charge cycles, for example.

FIG. 7 illustrates a block diagram of a computing module, e.g., control circuitry, in accordance with some examples of the disclosure. In some examples, computing module 702 may be communicatively connected to a user interface (not shown). In some examples, computing module 702, may be the control circuitry 630 and/or control circuitry of vehicle 600 as described with reference to FIG. 6 above. In some examples, computing module 702 may include processing circuitry, control circuitry, and storage (e.g., RAM (Random Access Memory), ROM (Read Only Memory), hard disk, removable disk, etc.). Computing module 702 may include an input/output path 720. I/O path 720 may provide device information, or other data, over a local area network (LAN) or wide area network (WAN), and/or other content and data to control circuitry 710, which includes processing circuitry 714 and storage 712. Control circuitry 710 may be used to send and receive commands, requests, signals (digital and analogue), and other suitable data using I/O path 720, which may comprise I/O circuitry. I/O path 720 may connect control circuitry 710 (and specifically processing circuitry 1014) to one or more communications paths. In some examples, computing module 702 may be an onboard computer of a vehicle, such as a vehicle 600.

Control circuitry 710 may be based on any suitable processing circuitry such as processing circuitry 714. As referred to herein, processing circuitry should be understood to mean circuitry based on one or more microprocessors, microcontrol circuitrys, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some examples, processing circuitry may be distributed across multiple separate processors or processing units, for example, multiple of the same type of processing units (e.g. two Intel Core i7 processors) or multiple different processors (e.g., an Intel Core i5 processor and an Intel Core i7 processor). In some examples, control circuitry 714 executes instructions for a computing module stored in memory (e.g., storage 712).

The memory may be an electronic storage device provided as storage 712, which is part of control circuitry 710. As referred to herein, the phrase “electronic storage device” or “storage device” should be understood to mean any device (physical or cloud-based) for storing electronic data, computer software, or firmware, such as random-access memory, read-only memory, hard drives, solid-state devices, quantum storage devices, or any other suitable fixed or removable storage devices, and/or any combination of the same. The non-volatile memory may also be used (e.g., to launch a boot-up routine and other instructions). Storage 712 may be subdivided into different spaces such as kernel space and user space. Kernel space is a portion of memory or storage that is, e.g., reserved for running a privileged operating system kernel, kernel extensions, and most device drivers. User space may be considered an area of memory or storage where application software generally executes and is kept separate from kernel space so as to not interfere with system-vital processes. Kernel mode may be considered as a mode when a control circuitry has permission to operate on data in kernel space, while applications running in user mode must request control circuitry 710 to perform tasks in kernel mode on its behalf.

Computing module 702 may be coupled to a communications network, e.g., for retrieving data from storage 712. The communication network may be one or more networks including the Internet, a mobile phone network, a mobile voice or data network (e.g., a 3G, 4G, 5G or LTE network), a mesh network, peer-to-peer network, cable network, cable reception (e.g., coaxial), microwave link, DSL (Digital Subscriber Line) reception, cable internet reception, fibre reception, over-the-air infrastructure or other types of communications network or combinations of communications networks. Computing module 702 may be coupled to a second communication network (e.g., Bluetooth, Near Field Communication, service provider proprietary networks, or wired connection) to retrieve information such as regenerative braking profiles. Paths may separately or together include one or more communications paths, such as a satellite path, a fiber-optic path, a cable path, a path that supports Internet communications, free-space connections (e.g., for broadcast or other wireless signals), or any other suitable wired or wireless communications path or combination of such paths.

In some examples, the control circuitry 710 is configured to carry out any of the methods as described herein. For example, storage 712 may be a non-transitory computer-readable medium having instructions encoded thereon, to be carried out by processing circuitry 714, which causes control circuitry 710 to carry out a method of optimized charging.

It should be understood that the examples described above are not mutually exclusive with any of the other examples described with reference to FIGS. 1-7. The order of the description of any examples is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Other variations to the disclosed examples can be understood and effected by those skilled in the art in practising the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

The disclosure of this invention is made to illustrate the general principles of the systems and processes discussed above and is intended to be illustrative rather than limiting. More generally, the above disclosure is meant to be exemplary and not limiting and the scope of the invention is best determined by reference to the appended claims. In other words, only the claims that follow are meant to set bounds as to what the present disclosure includes.

While the present disclosure is described with reference to particular example applications, it shall be appreciated that the invention is not limited thereto. It will be apparent to those skilled in the art that various modifications and developments may be made without departing from the scope and spirit of the present invention. Those skilled in the art would appreciate that the actions of the processes discussed herein may be omitted, modified, combined, and/or rearranged, and any additional actions may be performed without departing from the scope of the invention.

Any system feature as described herein may also be provided as a method feature and vice versa. As used herein, means plus function features may be expressed alternatively in terms of their corresponding structure. It shall be further appreciated that the systems and/or methods described above may be applied to, or used in accordance with, other systems and/or methods.

Any feature in one aspect may be applied to other aspects, in any appropriate combination. In particular, method aspects may be applied to system aspects, and vice versa. Furthermore, any, some, and/or all features in one aspect can be applied to any, some, and/or all features in any other aspect, in any appropriate combination. It should also be appreciated that particular combinations of the various features described and defined in any aspect can be implemented and/or supplied and/or used independently.

The following items pertain to further examples of the present disclosure:

Example 1 is method for optimizing charging of a vehicle, the method comprising: providing a charging current to a battery pack of a vehicle from an external power source; detecting a change in volume of one or more battery cells of a battery pack; and reducing the charging current as a function of the volume increase of the one or more battery cells of the battery pack.

Example 2 comprises Example 1, wherein the charging is provided at rate greater than 1C.

Example 3 comprises Examples 1-2, further comprising: receiving, from at least one sensor, a voltage value; comparing the detected voltage value with a threshold voltage value; determining the detected voltage value has exceeded the threshold voltage value; and wherein the function reducing the charging current is further based on the magnitude of the detected voltage value over the threshold voltage value.

Example 4 comprises Example 3, further comprising: determining the detected voltage value has fallen below the threshold voltage value; wherein the function reducing the charging current is no longer based on the magnitude first voltage value over the threshold voltage value.

Example 5 comprises Examples 1-4, further comprising: receiving, form at least one sensor, a current value; comparing the detected current value with a threshold current value; determining the detected current value has exceeded the threshold current value; wherein the function reducing the charging current is further based on the magnitude of the detected current value over the threshold current value.

Example 6 comprises Example 5, further comprising: determining the detected current value has fallen below the threshold current value; wherein the function reducing the charging current is no longer based on the magnitude first current value over the threshold current value.

Example 7 comprises Examples 1-6, wherein at least a first pressure measuring sensor is provided in a space directly between adjacent battery cells among the one or more battery cells and is configured to measure pressure applied directly by the adjacent battery cells and output a voltage or current value corresponding to the pressure.

Example 8 comprises Examples 1-7, wherein a second pressure measuring sensor is provided in a space formed by an outermost battery cell among the one or more battery cells and an inner wall of the battery pack and is configured to measure pressure applied directly by the outermost battery cell and output a voltage or current calue corresponding to the pressure.

Example 9 comprises Examples 1-8, wherein at least a first temperature measuring sensor is provided in a space directly between adjacent battery cells among the one or more battery cells and is configured to measure temperature from the adjacent battery cells and output a voltage or current value corresponding to the temperature.

Example 10 comprises Examples 1-9, wherein at least a first camera sensor is provided in a space with a view of one or more battery cells and is configured to measure at least one dimensions from the one or more battery cells and output a voltage or current value corresponding to the dimensions.

Example 11 comprises Examples 1-10, wherein at least a first camera sensor is provided in a space with a view of one or more battery cells and is configured to measure at least one dimension from the one or more battery cells and output a voltage or current value corresponding to the dimension measured.

Example 12 comprises a system for optimizing charging in a vehicle based on swelling detection, the system comprising: a detecting unit communicatively coupled to a battery pack, wherein the detecting unit is configured to detect a change in volume of one or more battery cells of the battery pack; a control unit in electrical connection with the battery pack and an external power source, wherein the control unit is configured to: provide a charging current to the battery pack from the external power source; and reduce the charging current as a function of the volume increase of the one or more battery cells of the battery pack.

Example 13 comprises Example 12, wherein the charging is provided at rate greater than 1C.

Example 14 comprises Examples 12-13, further comprising: receiving, from at least one sensor, a voltage value; comparing the detected voltage value with a threshold voltage value; determining the detected voltage value has exceeded the threshold voltage value; and wherein the function reducing the charging current is further based on the magnitude of the detected voltage value over the threshold voltage value.

Example 15 comprises Example 14, further comprising: determining the detected voltage value has fallen below the threshold voltage value; wherein the function reducing the charging current is no longer based on the magnitude first voltage value over the threshold voltage value.

Example 16 comprises Examples 12-15, further comprising: receiving, form at least one sensor, a current value; comparing the detected current value with a threshold current value; determining the detected current value has exceeded the threshold current value; wherein the function reducing the charging current is further based on the magnitude of the detected current value over the threshold current value.

Example 17 comprises Example 16, further comprising: determining the detected current value has fallen below the threshold current value; wherein the function reducing the charging current is no longer based on the magnitude first current value over the threshold current value.

Example 18 comprises Examples 12-17, wherein at least a first pressure measuring sensor is provided in a space directly between adjacent battery cells among the one or more battery cells and is configured to measure pressure applied directly by the adjacent battery cells and output a voltage or current value corresponding to the pressure.

Example 19 comprises Examples 12-18, wherein a second pressure measuring sensor is provided in a space formed by an outermost battery cell among the one or more battery cells and an inner wall of the battery pack and is configured to measure pressure applied directly by the outermost battery cell and output a voltage or current calue corresponding to the pressure.

Example 20 comprises Examples 12-19, wherein at least a first temperature measuring sensor is provided in a space directly between adjacent battery cells among the one or more battery cells and is configured to measure temperature from the adjacent battery cells and output a voltage or current value corresponding to the temperature.

Example 21 comprises Examples 12-20, wherein at least a first camera sensor is provided in a space with a view of one or more battery cells and is configured to measure at least one dimensions from the one or more battery cells and output a voltage or current value corresponding to the dimensions.

Example 22 comprises Examples 12-21, wherein at least a first camera sensor is provided in a space with a view of one or more battery cells and is configured to measure at least one dimension from the one or more battery cells and output a voltage or current value corresponding to the dimension measured.

Example 23 comprises a vehicle comprising a system for optimizing charging in a vehicle based on swelling detection, the system comprising: a detecting unit communicatively coupled to a battery pack, wherein the detecting unit is configured to detect a change in volume of one or more battery cells of the battery pack; a control unit in electrical connection with the battery pack and an external power source, wherein the control unit is configured to: provide a charging current to the battery pack from the external power source; and reduce the charging current as a function of the volume increase of the one or more battery cells of the battery pack.

Example 24 comprises Example 23, wherein the charging is provided at rate greater than 1C.

Example 25 comprises Examples 23-24, wherein the detecting unit further comprises a pressure, temperature or camera sensor, the control unit further configured to: received, from at least one sensor, a voltage value; compare the detected voltage value with a threshold voltage value; determine the detected voltage value has exceeded the threshold voltage value; and wherein the function reducing the charging current is further based on the magnitude of the detected voltage value over the threshold voltage value.

Example 26 comprises Example 25, the control unit further configured to: determine the detected voltage value has fallen below the threshold voltage value; wherein the function reducing the charging current is no longer based on the magnitude first voltage value over the threshold voltage value.

Example 27 comprises Examples 23-26, wherein the detecting unit further comprises a pressure, temperature or camera sensor, the control unit further configured to: receive, form at least one sensor, a current value; compare the detected current value with a threshold current value; determine the detected current value has exceeded the threshold current value; wherein the function reducing the charging current is further based on the magnitude of the detected current value over the threshold current value.

Example 28 comprises Example 27, the control unit further configured to: determine the detected current value has fallen below the threshold current value; wherein the function reducing the charging current is no longer based on the magnitude first current value over the threshold current value.

Example 29 comprises Examples 23-28, the system further comprising a first pressure measuring sensor provided in a space directly between adjacent battery cells among the one or more battery cells and is configured to measure pressure applied directly by the adjacent battery cells and output a voltage or current value corresponding to the pressure.

Example 30 comprises Examples 23-29, the system further comprising a second pressure measuring sensor provided in a space formed by an outermost battery cell among the one or more battery cells and an inner wall of the battery pack and is configured to measure pressure applied directly by the outermost battery cell and output a voltage or current calue corresponding to the pressure.

Example 31 comprises Examples 23-30, the system further comprising a first temperature measuring sensor provided in a space directly between adjacent battery cells among the one or more battery cells and is configured to measure temperature from the adjacent battery cells and output a voltage or current value corresponding to the temperature.

Example 32 comprises Examples 23-32, the system further comprising a first camera sensor is provided in a space with a view of one or more battery cells and is configured to measure at least one dimension from the one or more battery cells and output a voltage or current value corresponding to the dimension measured.

Example 33 is a non-transitory computer-readable medium, having instructions recorded thereon for configuring electronic fuses based on peripheral devices connected to a vehicle system, the instructions, when executed by control circuitry, cause the control circuitry to: provide a charging current to a battery pack of a vehicle from an external power source; detect a change in volume of one or more battery cells of a battery pack; reduce the charging current as a function of the volume increase of the one or more battery cells of the battery pack.

Example 34 comprises Example 33, wherein the charging is provided at rate greater than 1C.

Example 35 comprises Examples 33-34, the non-transitory computer-readable medium further configured to: receive, from at least one sensor, a voltage value; comparing the detected voltage value with a threshold voltage value; determining the detected voltage value has exceeded the threshold voltage value; and wherein the function reducing the charging current is further based on the magnitude of the detected voltage value over the threshold voltage value.

Example 36 comprises Example 35, the non-transitory computer-readable medium further configured to: determine the detected voltage value has fallen below the threshold voltage value; wherein the function reducing the charging current is no longer based on the magnitude first voltage value over the threshold voltage value.

Example 37 comprises Examples 33-36, the non-transitory computer-readable medium further configured to: receive, form at least one sensor, a current value; comparing the detected current value with a threshold current value; determining the detected current value has exceeded the threshold current value; wherein the function reducing the charging current is further based on the magnitude of the detected current value over the threshold current value.

Example 38 comprises Example 37, the non-transitory computer-readable medium further configured to: determining the detected current value has fallen below the threshold current value; wherein the function reducing the charging current is no longer based on the magnitude first current value over the threshold current value.

Example 39 comprises Examples 33-38, wherein at least a first pressure measuring sensor is provided in a space directly between adjacent battery cells among the one or more battery cells and is configured to measure pressure applied directly by the adjacent battery cells and output a voltage or current value corresponding to the pressure.

Example 40 comprises Examples 33-39, wherein a second pressure measuring sensor is provided in a space formed by an outermost battery cell among the one or more battery cells and an inner wall of the battery pack and is configured to measure pressure applied directly by the outermost battery cell and output a voltage or current calue corresponding to the pressure.

Example 41 comprises Examples 33-40, wherein at least a first temperature measuring sensor is provided in a space directly between adjacent battery cells among the one or more battery cells and is configured to measure temperature from the adjacent battery cells and output a voltage or current value corresponding to the temperature.

Example 42 comprises Examples 33-41, wherein at least a first camera sensor is provided in a space with a view of one or more battery cells and is configured to measure at least one dimensions from the one or more battery cells and output a voltage or current value corresponding to the dimensions.

Example 43 comprises Examples 33-42, wherein at least a first camera sensor is provided in a space with a view of one or more battery cells and is configured to measure at least one dimension from the one or more battery cells and output a voltage or current value corresponding to the dimension measured.

What is claimed is:

1. A method for optimizing charging of a vehicle, the method comprising:
providing a charging current to a battery pack of the vehicle from an external power source;
detecting a change in volume of one or more battery cells of the battery pack; and
adjusting the charging current as a function of the volume change of the one or more battery cells of the battery pack.

2. The method of claim 1, wherein the charging is provided at a C-rate greater than 1C.

3. The method of claim 1, wherein the function that describes the charging current is a Multi-Stage Constant Current-Constant Voltage, MSCC-CV, function.

4. The method of claim 1, further comprising:
receiving, from at least one sensor, a voltage value;
comparing the voltage value with a threshold voltage value; and
determining whether the voltage value has exceeded the threshold voltage value; and
wherein the function adjusting the charging current is based on a magnitude of the voltage value over the threshold voltage value.

5. The method of claim 4, further comprising:
determining whether the voltage value has fallen below the threshold voltage value; and
wherein the function adjusting the charging current is no longer based on the magnitude of the voltage value over the threshold voltage value.

6. The method of claim 1, further comprising:
receiving, from at least one sensor, a current value;
comparing the current value with a threshold current value; and
determining whether the current value has exceeded the threshold current value; and
wherein the function adjusting the charging current is based on a magnitude of the current value over the threshold current value.

7. The method of claim 6, further comprising:
determining whether the current value has fallen below the threshold current value; and
wherein the function adjusting the charging current is no longer based on the magnitude of the current value over the threshold current value.

8. The method of claim 1, wherein at least a first pressure measuring sensor is provided in a space directly between adjacent battery cells among the one or more battery cells and is configured to measure pressure applied directly by the adjacent battery cells and output a voltage or current value corresponding to the pressure.

9. The method of claim 8, wherein a second pressure measuring sensor is provided in a space formed by an outermost battery cell among the one or more battery cells and an inner wall of the battery pack and is configured to measure pressure applied directly by the outermost battery cell and output a voltage or current value corresponding to the pressure.

10. The method of claim 1, wherein at least a first temperature measuring sensor is provided in a space directly between adjacent battery cells among the one or more battery cells and is configured to measure temperature from the adjacent battery cells and output a voltage or current value corresponding to the temperature.

11. The method of claim 1, wherein at least a first camera sensor is provided in a space with a view of one or more battery cells and is configured to measure at least one dimension from the one or more battery cells and output a voltage or current value corresponding to the dimension measured.

12. A system for optimizing charging based on swelling detection, the system comprising:
a detecting unit communicatively coupled to a battery pack, wherein the detecting unit is configured to detect a change in volume of one or more battery cells of the battery pack; and
a control unit in electrical connection with the battery pack and an external power source, wherein the control unit is configured to:
provide a charging current to the battery pack from the external power source; and
adjust the charging current as a function of the volume change of the one or more battery cells of the battery pack.

13. The system of claim 12, wherein the charging is provided at a C-rate greater than 1C.

14. The system of claim 12, wherein the detecting unit further comprises a pressure, temperature or camera sensor, the control unit further configured to:
receive, from at least one sensor, a voltage value;
compare the voltage value with a threshold voltage value; and
determine whether the voltage value has exceeded the threshold voltage value; and
wherein the function adjusting the charging current is based on a magnitude of the detected voltage value over the threshold voltage value.

15. The system of claim 14, the control unit further configured to:
determine the whether the voltage value has fallen below the threshold voltage value;
wherein the function adjusting the charging current is no longer based on the magnitude first voltage value over the threshold voltage value.

16. The system of claim 12, wherein the detecting unit further comprises a pressure, temperature or camera sensor, the control unit further configured to:
receive, from at least one sensor, a current value;
compare the current value with a threshold current value; and
determine whether the current value has exceeded the threshold current value;
wherein the function adjusting the charging current is based on a magnitude of the current value over the threshold current value.

17. The system of claim 16, the control unit further configured to:
determine whether the current value has fallen below the threshold current value;
wherein the function reducing the charging current is no longer based on the magnitude first current value over the threshold current value.

18. The system of claim 17, further comprising a first pressure measuring sensor provided in a space directly between adjacent battery cells among the one or more battery cells and is configured to measure pressure applied directly by the adjacent battery cells and output a voltage or current value corresponding to the pressure.

19. A vehicle comprising the system of claim 12.

20. A non-transitory computer-readable medium, having instructions recorded thereon for optimizing charging based on swelling detection, the instructions, when executed by control circuitry, cause the control circuitry to:
provide a charging current to a battery pack of a vehicle from an external power source;
detect a change in volume of one or more battery cells of the battery pack; and
adjust the charging current as a function of the volume change of the one or more battery cells of the battery pack.
